(19) United States
(12) Patent Application Publication
(10) Pub. No.: US 2023/0267333 A1
(43) Pub. Date: Aug. 24, 2023

(54) REPARAMETERIZATION OF SELECTIVE NETWORKS FOR END-TO-END TRAINING

(71) Applicant: Royal Bank of Canada, Toronto (CA)

(72) Inventors: Mahmoud Salem, London (CA); Frederick Tung, Toronto (CA); Mohamed O. Ahmed, Vancouver (CA); Gabriel Oliveira, Vancouver (CA)

(21) Appl. No.: 18/113,492

(22) Filed: Feb. 23, 2023

Related U.S. Application Data
(60) Provisional application No. 63/313,187, filed on Feb. 23, 2022.

(51) Int. Cl. G06N 3/084

(52) U.S. Cl. CPC G06N 3/084

(57) ABSTRACT

A method is provided for training a selective network that includes a selection node for selecting whether to make a prediction. During training, the selection node is reparameterized as a differentiable function of learnable parameters acting on noise from a base distribution. The differentiable function approximates a sampling from a categorical distribution.

### CROSS-REFERENCE TO RELATED APPLICATION

This application claims priority to U.S. Provisional Patent Application No. 63/313,187 filed on Feb. 23, 2022, the teachings of which are hereby incorporated by reference.

### TECHNICAL FIELD

The present disclosure relates to artificial intelligence (AI), and more particularly to training of selective networks.

### BACKGROUND

In many real-world AI applications, the ability to assess model uncertainty and adapt the system behavior accordingly is critical. There is an extensive body of work that addresses the challenges of detecting when a model is highly uncertain (Gal et al., 2017, Lakshminarayanan et al., 2017, Corbière et al., 2019, Maddox et al., 2019, Antorán et al., 2020, Liu et al., 2020, Dusenberry et al., 2020, Durasov et al., 2021). In practice, it is useful for an AI system to have the option of abstaining from making a prediction or decision when it detects a situation of high uncertainty. When an AI model is uncertain about its prediction, for example due to the uniqueness of the input with respect to previously observed training samples, it is often preferable for the model to abstain from making a prediction, instead of making a poor prediction that could erode user confidence or lead to harmful downstream consequences. In cases of abstention, the system may fall back on expert judgment or safe defaults. Some prior approaches to abstention policy include custom-built abstention rules (e.g., thresholding based on the softmax response (Geifman and El-Yaniv, 2017) or predictive uncertainty (Malinin et al., 2017)) applied post-hoc at inference time.

The automatic learning of an abstention policy would free AI system developers from having to hand-craft a set of selection rules based on heuristics. Given that the system has the option to abstain, an important question to ask is how to train the model with the knowledge that it is allowed to abstain. By integrating this option into model training, the model can learn to automatically recognize and optimize for the part of the data distribution for which confident predictions can be made, instead of attempting to fit to the entire data distribution at training time and then applying hand-crafted abstention rules.

How to train a neural network with the knowledge that it is allowed to abstain has received relatively little attention in the AI community. Geifman and El-Yaniv (2019) proposed the modern selective network (SelectiveNet), which adds a dedicated selection head to the base network. Selective networks are trained with an integrated reject option, i.e., the option to abstain from making a prediction when the model is uncertain (Geifman and El-Yaniv, 2019). The network is trained to optimize the task performance criterion, such as classification accuracy, given a target level of coverage: the proportion of input samples for which the network should make predictions. For example, a target coverage of 90% means that the network should abstain at most 10% of the time. Liu et al. (2019) proposed to add the abstention option as a separate class that can be predicted. A threshold is applied to the score of the abstention class to achieve a desired level of coverage without re-training. However, this approach can be applied to classification networks only. Huang et al. (2020) used the selective classification task to illustrate the potential of their self-adaptive training technique.

Optimizing selective networks is challenging because of the non-differentiability of the binary selection operation (the decision of whether to select or abstain). In the conventional formulation of selective networks, the non-differentiability of selection is handled by replacing the binary selection operation with a soft relaxation. However, this approximation means that in practice the selective network does not perform selection during training, but instead assigns a soft instance weight to each training sample.

### SUMMARY

In one aspect, a method of training a selective network is provided. The selective network includes a selection node for selecting whether to make a prediction. During training, the selection node is reparameterized as a differentiable function of learnable parameters acting on noise from a base distribution. The differentiable function approximates a sampling from a categorical distribution.

In one preferred embodiment, the base distribution is the Gumbel distribution. In one implementation of this embodiment, during at least one forward pass of the network, argmax is used to perform selection at the selection node, and during at least one backward pass of the network, a softmax approximation of the argmax is used at the selection node to compute gradients. Preferably, the softmax approximation uses temperature annealing.

The noise may be i.i.d. noise.

In some embodiments, the prediction is a classification. In other embodiments, the prediction is a numerical value.

The selective network may be, for example, a convolutional network, a fully connected network, a residual network, or a recurrent network.

In other aspects, data processing systems and computer program products for implementing the method are also described.

### BRIEF DESCRIPTION OF THE DRAWINGS

These and other features will become more apparent from the following description in which reference is made to the appended drawings wherein:

FIG. 1 is a visual depiction of an illustrative method for training a selective network according to an aspect of the present disclosure;

FIG. 2 is a flow chart showing an illustrative method for training a selective network according to an aspect of the present disclosure; and

FIG. 3 is a block diagram of an illustrative computer system which may be used in implementing training of a selective network according to an aspect of the present disclosure.

### DETAILED DESCRIPTION

One aspect of the present disclosure presents selective networks that enable binary selection decisions during training while preserving end-to-end differentiability. In one preferred embodiment, the selective networks are adapted to use the Gumbel-softmax reparameterization technique (Jang et al., 2017, Maddison et al., 2017) and are referred to herein as “Gumbel-softmax selective networks”.

The technique for training selective networks described in the present disclosure is general and does not assume a particular prediction task (e.g. classification). It leverages a principled machine learning approach to perform selection or abstention within an end-to-end training framework. The method described herein is orthogonal to, and can be combined with, self-adaptive training technique (Huang et al., 2020). Experiments on public datasets demonstrate the potential of the selective networks described herein for both selective classification and selective regression tasks.

A selective neural network can be defined as a pair (f,g), where f is a prediction function and g is a binary selection function, such that the output of the network is given by Geifman and El-Yaniv (2019):

$$( f , g ) ( x ) = \{ \begin{matrix}f ( x ) if g ( x ) = 1 \\ Abstain if g ( x ) = 0\end{matrix} . \qquad ( 1 )$$

Selective networks trade off prediction performance against coverage: the proportion of input samples that the network selects (i.e., makes predictions for). Given a set of m training data points {(xᵢ, yᵢ)}ᵢ₌₁^{m}, the empirical coverage is defined as:

$$\hat{ϕ} ( g ) = \frac{1}{m} {\sum }_{i = 1}^{m} g ( {x}_{i} ) , \qquad ( 2 )$$

and the empirical selective risk is defined as:

$$\hat{r} ( f , g ) = \frac{\frac{1}{m} {\sum }_{i = 1}^{m} ℓ ( f ( {x}_{i} ) , {y}_{i} ) g ( {x}_{i} )}{\hat{ϕ} ( g )} , \qquad ( 3 )$$

where [symbol] is a loss function such as cross-entropy for classification or mean squared error for regression. These are merely illustrative loss functions and are not intended to be limiting. The overall training objective is then a weighted combination of the empirical selective risk and a penalty term that penalizes differences between the empirical coverage and a pre-specified target coverage:

[symbol]

_{(f,g)}=\hat{r}(f,g)+λΨ(c−\ddot{ϕ}(g)), (4)

where c is a pre-specified target coverage, Ψ is a penalty function (e.g. Ψ(a)=max(0, a)²), and λ is a balancing hyperparameter.

Optimizing Eq. 4 is challenging because of the non-differentiability of the binary selection function g. Geifman and El-Yaniv (2019) handle the non-differentiability of selection by replacing the binary function g with a relaxed function g: [symbol] →[0,1]. While this addresses the differentiability issue, the approximation means that in practice the selective network does not perform selection during training, but instead assigns a soft instance weight to each training sample. This is not aligned with the goal of the optimization process which aims at minimizing the loss over only the selected examples to achieve a desired coverage. To address this discrepancy, the present disclosure describes a differentiable method for enabling binary selection during training while preserving end-to-end training. In one preferred embodiment, this is achieved using the Gumbel-softmax reparameterization technique.

### Gumbel-Softmax Selective Networks

The reparameterization technique (Kingma and Welling, 2014, Rezende et al., 2014) in deep learning allows replacement of a stochastic computation graph by a differentiable computation graph with learnable parameters, acting on noise from a fixed base distribution. For example, consider a stochastic node in a neural network that performs sampling from a normal distribution parameterized by mean μ and standard deviation σ. It is not possible to backpropagate through this stochastic node because of the non-differentiability of the sampling operation. However, this stochastic node can be replaced with a parameterized differentiable computation that takes noise as input: the computation takes input noise sampled from the standard normal [symbol] (0,1), scales it by a, and then shifts the result by Since μ and σ can be generated by deterministic neural network layers trainable by backpropagation, this reparameterization effectively enables sampling from an arbitrary, learnable normal distribution. To reiterate, the dependency on parameters μ and σ is moved from the stochastic computation graph to a differentiable computation graph that acts on base noise.

Revisiting the conventional selective network formulation, the reparameterization technique can be used to perform binary selection while preserving end-to-end training. The output of g can be redefined as the probability of selecting the input (i.e., the probability the network should make the prediction instead of abstaining). The selection function becomes a stochastic operator that selects the input with probability g. Similar to the example noted above, there is a stochastic node that performs a sampling operation. However, instead of sampling from a normal distribution, the node should sample from the Bernoulli distribution, Bernoulli(g).

The Gumbel-softmax reparameterization technique (Jang et al., 2017, Maddison et al., 2017) allows reparameterization of a stochastic node that samples from a categorical distribution, again by replacing it with a differentiable function of learnable parameters, acting on noise from a base distribution. Given a categorical distribution of k events with probability π₁, . . . , πₖ, compute log π₁, . . . , log πₖ, and to each of these terms add i.i.d. noise sampled from the Gumbel distribution (Gumbel, 1954). A stochastic sample z (represented by a one-hot vector) can then be drawn by taking the argmax:

z=one_hot(arg maxᵢ[Gᵢ+log πᵢ]), (5)

where Gᵢ˜Gumbel(0,1). To allow end-to-end training, approximate the argmax with a softmax, which gives a softened vector \tilde{z}:

$${\tilde{z}}_{i} = \frac{exp ( ( log {π}_{i} + {G}_{i} ) ) / τ )}{{\sum }_{j = 1}^{k} exp ( ( log {π}_{j} + {G}_{j} ) / τ )} , for i = 1 , … , k \qquad ( 6 )$$

The temperature parameter τ>0 determines the sharpness of the softmax, and is annealed over time towards zero to recover the argmax. As τ→∞, the Gumbel-softmax distribution converges to the uniform distribution, and as τ→0, the Gumbel-softmax distribution converges to the categorical distribution. Therefore, the dependency on parameters π₁, . . . , πₖ has moved from the non-differentiable stochastic sampling function to a differentiable function consisting of softmax and log operations acting on base noise, which can be trained end-to-end with backpropagation.

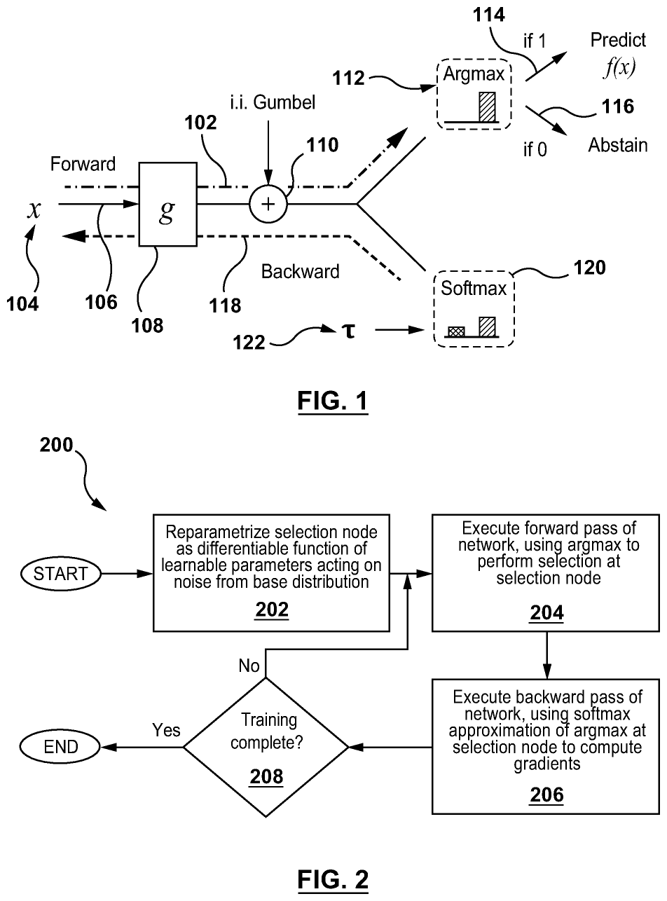

Combining the foregoing, binary selection is performed by applying the Gumbel-softmax reparameterization technique with π₁=g, π₂=1−g. In the forward pass, the argmax form is used to perform binary selection. In the backward pass, the softmax form with temperature annealing is used to compute gradients and enable end-to-end training. This variation of using argmax in the forward pass and softmax in the backward pass, as applied in contexts other than selecvtive networks, is also known as the straight-through Gumbel-softmax (Jang et al., 2017). FIG. 1 shows a visual summary of the proposed approach.

In FIG. 1, during a forward pass 102, input (x) 104 is fed 106 to a selection probability generator (g) 108 which generates initial probabilities of selection and abstention to which i.i.d. noise (+) is added 110 (see Eq. (5) above). Argmax 112 acts on the two probabilities, and selects whether to predict 114 or abstain 116. For a backward pass 118, a softmax 120 is calculated, with a temperature parameter (τ) 122 to compute gradients. The temperature parameter (τ) 122 is annealed over time such that the softmax 120 approaches the argmax 112.

Reference is now made to FIG. 2, which is a flow chart showing an illustrative method 200 for training a selective network that includes a selection node for selecting whether to make a prediction. The prediction may be, for example, a classification or a numerical value. The selective network may be, for example, any of a convolutional network, a fully connected network, a residual network, and a recurrent network, among others.

At step 202, the selection node is reparameterized as a differentiable function of learnable parameters acting on noise from a base distribution. As noted above, in one preferred embodiment, the base distribution is the Gumbel distribution and the noise is i.i.d. noise; other configurations are also contemplated. The differentiable function approximates a sampling from a categorical distribution.

At step 204, the method 200 executes a forward pass of the network, using argmax to perform selection at the selection node, and then proceeds to step 206. At step 206, the method 200 executes a backward pass of the network, using a softmax approximation of the argmax at the selection node to compute gradients. In one preferred embodiment, the softmax approximation uses temperature annealing.

At step 208, the method 200 tests whether training is complete, according to a predetermined criteria, for example a maximum number of epochs (iterations). If the training is complete (“yes” at step 208), the method 200 ends, although further actions, such as tuning or testing, may then be undertaken. If training is not complete (“no” at step 208), the method 200 returns to step 204 for another forward pass. Thus, there is at least one forward pass and at least one backward pass; in most embodiments there will be many forward and backward passes.

### Experimental Results

This section describes a set of experiments used to validate the effectiveness and generalization of Gumbel-softmax selective networks according to the present disclosure.

### Baselines

Baselines are grouped into two categories: techniques that are applicable to general purpose selective networks (i.e., unconstrained to a particular prediction task) and techniques that are specialized to classification networks. While the goal of the present disclosure is to develop a technique for training general purpose selective networks, for completeness the latter category of baselines is included due to their state-of-the-art performance on selective classification benchmarks.

### General Purpose Selective Networks

One direct comparison is with conventional selective network training (Geifman and El-Yaniv, 2019), which is described above. This baseline is denoted as SelectiveNet in the experimental results. A comparison is also drawn with MC-dropout (Gal and Ghahramani, 2016), which estimates model uncertainty by performing multiple forward passes with dropout.

### Specialized Selective Networks

On the selective classification benchmarks, baselines include Deep Gamblers (Liu et al., 2019), as well as Softmax Response (Geifman and El-Yaniv, 2017), which uses the maximum softmax output value as a measure of the confidence of a classification network.

### Datasets

CIFAR-10 (Krizhevsky, 2009) is a standard benchmark in selective networks evaluation (Geifman and El-Yaniv, 2019, Liu et al., 2019, Huang et al., 2020). This image classification benchmark consists of 32×32 resolution RGB images covering ten object classes. The training set contains 50,000 images and the testing set contains 10,000 images.

Cats vs. Dogs (Elson et al., 2007) is an additional image classification benchmark that is used to evaluate selective networks (Geifman and El-Yaniv, 2019, Liu et al., 2019). It consists of 25,000 images of cats and dogs with an even split between classes. This dataset does not specify a standard training-testing split. The publicly released training-testing split of (Liu et al., 2019), which consists of 80% of the images for training and 20% for testing, was adopted.

ImageNet-100 (Tian et al., 2019) is a 100-class subset of ImageNet. Details on its construction can be found in the supplementary of Tian et al., 2019.

Concrete Compressive Strength (Yeh, 1998) is a regression dataset from the UCI Machine Learning Repository (Dua and Graff, 2017) that is used in the experimental evaluation of SelectiveNet (Geifman and El-Yaniv, 2019). It consists of 1,030 instances and the task is to predict the compressive strength given eight numerical input variables. As there is no standard training-testing split, the dataset was randomly split into 60% for training, 20% for held-out validation, and 20% for testing. After tuning hyperparameters on the validation set, the final models were trained on the combined training-validation set and the results were generated on the testing set.

California Housing (Pace and Barry, 1997) is an additional regression dataset. It consists of 20,640 instances and the task is to predict median housing values of California districts given eight input features. As there is no standard training-testing split, the dataset was randomly split into 80% for training (16,512 instances) and 20% for testing (4,128 instances). For hyperparameter searching purposes, the training set was further divided into 80% training and 20% validation. After hyperparameter exploration, the combined training-validation set is used to train the final models for evaluation on the testing set.

Ames Housing (De Cock, 2011) is a house price regression dataset featuring houses sold in Ames, Iowa during the period from 2006 to 2010. The dataset has 1,460 instances and the goal is to predict the sale price of the house. The dataset includes 79 features divided into categorical and numerical. Columns with more than 80% of samples missing, which are Alley, PoolQC, MiscFeature and Fence, were dropped. GarageYrBlt was also removed due to high redundancy to the MasVnrArea feature. The training set contains 1,022 instances and the testing set contains 438 instances. For hyperparameter searching purposes the training set is further divided into 70% training and 30% validation. After hyperparameter exploration the entire 1022/438 training/testing set is used to generate the final results. The dataset contains a number of missing values in both its numerical and categorical features. In order to replace the missing values, mean value imputation is performed along each numerical column and most frequent value for each categorical column. Additionally, categorical data was also converted to one-hot encoding representation to obtain the final configuration used during experiments.

### Implementation Details

Following the recommendation in Geifman and El-Yaniv (2019), an auxiliary prediction head was used as a regularizer during training. The auxiliary head is discarded after training and there is no additional overhead at inference time.

In the classification experiments for CIFAR-10 and Cats vs. Dogs, Geifman and El-Yaniv (2019) was followed by adjusting the VGG-16 architecture to small datasets and image sizes as proposed in Liu and Deng, 2015 by using one fully connected layer with 512 neurons instead of two, adding batch normalization and dropout. In the classification experiments for ImageNet-100, the ResNet-34 architecture (He et al., 2016) was used. Standard data augmentation was used in all classification experiments consisting of horizontal flips, vertical and horizontal shifts, and rotations. Stochastic gradient descent (SGD) was used for optimization with momentum 0.9 and starting with initial learning rate of 0.1. The training schedule was lengthened by a factor of two, applying a learning rate decay of 0.5 every 50 epochs for CIFAR-10 and Cats vs. Dogs and every 100 epochs for ImageNet-100 for a total of 600 epochs. The Gumbel-softmax temperature τ was initialized to 5 and annealed using multi-step decay by the rate of 0.985 every 5 epochs.

In the regression experiments, multilayer perceptron (MLP) backbones were adopted. For the Concrete Compressive Strength (CCS) dataset, a single hidden layer MLP with 64 neurons with ReLU and batch normalization was utilized, following the same setting from Geifman and El-Yaniv (2019). The California Housing dataset backbone is composed of a MLP with two hidden layers of 100 neurons each with ReLU. For the Ames Housing dataset, a two hidden layer MLP with 100 neurons with ReLU and batch normalization was used. The networks were trained for 800 epochs for the CCS and Ames datasets and for 1000 epochs for the California Housing dataset. All datasets used adam as optimizer, with initial learning rate of 0.007 and decay at epochs 400, 500, 600, 700 with a factor of 0.5 for the CCS dataset, an initial learning rate of 0.007 and decay at epochs 250, 500, 750 with a factor of 0.1 for the California Housing dataset, and an initial learning rate of 0.007 and decay at epochs 150, 250 with a factor of 0.1 for the Ames Housing dataset. The Gumbel-softmax temperature τ was initialized to 30 and annealed using multi-step decay by the rate of 0.985 every 5 epochs for the Concrete Compressive Strength and California Housing datasets. The Ames Housing dataset used an initial τ of 10 and annealed τ using multi-step decay by the rate of 0.995 every 5 epochs.

### Coverage Calibration

Selective networks trained at the same level of target coverage may differ in the actual coverage achieved in evaluation (i.e., the number of predictions made on the test set) due to distribution shift or random train-test variations. For a fair comparison, coverage calibration (Geifman and El-Yaniv, 2019, Liu et al., 2019) was applied to equalize the number of test predictions across all approaches. For example, when evaluating at a coverage level of 70%, the error metrics over the 70% most confident predictions (highest g values) among the test samples were computed.

However, this evaluation protocol has a shortcoming in that it does not reflect how a selective network operates in a real-world system. In practice, a selective model makes binary selection decisions to achieve an empirical coverage that ideally matches the target coverage. Therefore, additional results are reported without calibration in the regression experiments for the Concrete Compressive Strength and California Housing datasets (in the classification experiments, the calibrated results reported in Geifman and El-Yaniv (2019) are directly quoted as the reported results were not reproduced in the experiments).

### Selective Classification Results

Table 1 summarizes the experimental results on the CIFAR-10 and Cats vs. Dogs classification benchmarks. Table 1 compares classification error rates at the same coverage levels considered by previous work (Geifman and El-Yaniv, 2019, Liu et al., 2019). Results on both datasets are averaged over five trials.

TABLE 1
Selective classification error rate (%) on CIFAR-10 and Cats vs. Dogs
datasets. Results for SelectiveNet, MC-dropout, and Softmax Response are
quoted from Geifman and El-Yaniv (2019). Results for Deep Gamblers are
quoted from Liu et al. (2019). We group the results into techniques for
general purpose networks and for classification specific networks, and
highlight in bold the lowest error rates within each group.

| | | General purpose networks | | | Classification networks | |
|---|---|---|---|---|---|---|
| | | Gumbel- | | MC- | Deep | Softmax |
| Dataset | Coverage | softmax | SelectiveNet | dropout | Gamblers | Response |
| CIFAR-10 | 100 | 5.91 ± 0.13 | 6.79 ± 0.03 | 6.79 ± 0.03 | 6.12 ± 0.09 | 6.79 ± 0.03 |
| | 95 | 3.89 ± 0.21 | 4.16 ± 0.09 | 4.58 ± 0.05 | 3.49 ± 0.15 | 4.55 ± 0.07 |
| | 90 | 2.05 ± 0.04 | 2.43 ± 0.08 | 2.92 ± 0.01 | 2.19 ± 0.12 | 2.89 ± 0.03 |
| | 85 | 1.26 ± 0.10 | 1.43 ± 0.08 | 1.82 ± 0.09 | 1.09 ± 0.15 | 1.78 ± 0.09 |
| | 80 | 0.94 ± 0.10 | 0.86 ± 0.06 | 1.08 ± 0.05 | 0.66 ± 0.11 | 1.05 ± 0.07 |
| | 75 | 0.74 ± 0.08 | 0.48 ± 0.02 | 0.66 ± 0.05 | 0.52 ± 0.03 | 0.63 ± 0.04 |
| | 70 | 0.56 ± 0.08 | 0.32 ± 0.01 | 0.43 ± 0.05 | 0.43 ± 0.07 | 0.42 ± 0.06 |
| Cats vs. Dogs | 100 | 2.88 ± 0.23 | 3.58 ± 0.04 | 3.58 ± 0.04 | 2.93 ± 0.17 | 3.58 ± 0.04 |
| | 95 | 1.41 ± 0.18 | 1.62 ± 0.05 | 1.92 ± 0.06 | 1.23 ± 0.12 | 1.91 ± 0.08 |
| | 90 | 0.85 ± 0.10 | 0.93 ± 0.01 | 1.10 ± 0.05 | 0.59 ± 0.13 | 1.10 ± 0.08 |
| | 85 | 0.50 ± 0.08 | 0.56 ± 0.08 | 1.82 ± 0.09 | 0.47 ± 0.10 | 1.78 ± 0.09 |
| | 80 | 0.44 ± 0.09 | 0.35 ± 0.09 | 0.55 ± 0.02 | 0.46 ± 0.08 | 0.68 ± 0.05 |

Compared with conventional selective networks, Gumbel-softmax selective networks obtain an improvement in classification accuracy at higher coverage levels on CIFAR-10 (80%+coverage) and Cats vs. Dogs (85%+coverage). While improvements at lower coverage levels were not observed, this is not considered probative because strict comparisons on these datasets below 80% coverage are difficult due to the very low error rates (Liu et al., 2019). The performance of Gumbel-softmax selective networks approaches the state-of-the-art Deep Gamblers: in many of the evaluated coverage levels, the difference in accuracy between Gumbel-softmax selective networks and Deep Gamblers is within one standard deviation. This result supports the utility of Gumbel-softmax selective networks because Deep Gamblers is tailored to classification tasks, while Gumbel-softmax selective networks are more generally applicable to other predictive tasks, such as regression, which is discussed in the next section.

TABLE 2
Selective classification results on ImageNet-100.
Lowest error rates are highlighted in bold.

ImageNet-100
Top-1 Accuracy (↑)

| Coverage | Gumbel-softmax | SelectiveNet |
|---|---|---|
| 100 | 86.16 ± 0.15 | 86.07 ± 0.11 |
| 90 | 89.76 ± 0.64 | 88.68 ± 0.30 |
| 80 | 93.33 ± 0.47 | 92.59 ± 0.18 |
| 70 | 96.03 ± 0.33 | 95.86 ± 0.45 |
| 60 | 97.79 ± 0.34 | 97.83 ± 0.28 |
| 50 | 99.12 ± 0.49 | 99.06 ± 0.23 |

Table 2 summarizes the experimental results on the ImageNet-100 dataset, averaged over five trials following Feng et al., 2022 (which is explicitly denied to be prior art). Gumbel-softmax selective networks modestly outperform SelectiveNets at higher coverage levels; both methods perform comparably at lower coverage levels.

### Selective Regression Results

Tables 3, 4, 5, 6 and 7 summarize the experimental results for Gumbel-softmax selective networks and SelectiveNets on the regression datasets, averaged over five trials. All models were trained from scratch, and for a fair comparison all shared hyperparameters and train budgets are the same. Regression error metrics are reported for coverages ranging from 100% to 50%. In Tables 4 and 6, empirical coverage refers to the actual coverage achieved on the test samples. Mean squared error is computed over the selected (non-abstained) test samples.

TABLE 3
Selective mean squared error on Concrete
Compressive Strength dataset.

| Coverage | Gumbel-softmax | SelectiveNet |
|---|---|---|
| 100 | 32.84 ± 2.50 | 32.82 ± 0.67 |
| 90 | 25.13 ± 1.22 | 26.56 ± 2.82 |
| 80 | 21.15 ± 0.83 | 21.80 ± 3.25 |
| 70 | 16.17 ± 1.85 | 18.59 ± 2.50 |
| 60 | 13.72 ± 2.44 | 17.59 ± 2.23 |
| 50 | 11.15 ± 2.11 | 14.43 ± 2.57 |

TABLE 4
Non-calibrated results on the Concrete
Compressive Strength dataset.

| | Gumbel-softmax | | SelectiveNet | |
|---|---|---|---|---|
| | Empirical | Mean Squared | Empirical | Mean Squared |
| Coverage | Coverage | Error | Coverage | Error |
| 100 | 96.63 ± 0.98 | 29.09 ± 2.34 | 99.96 ± 0.01 | 32.73 ± 0.62 |
| 90 | 89.48 ± 1.12 | 25.12 ± 1.14 | 93.23 ± 0.60 | 28.67 ± 2.39 |
| 80 | 81.92 ± 1.47 | 22.12 ± 1.49 | 83.82 ± 1.38 | 23.32 ± 3.51 |
| 70 | 71.67 ± 1.35 | 17.78 ± 2.27 | 75.90 ± 0.61 | 19.90 ± 2.32 |
| 60 | 61.77 ± 0.93 | 14.46 ± 2.66 | 63.95 ± 0.66 | 18.67 ± 1.70 |
| 50 | 51.07 ± 2.25 | 11.08 ± 2.01 | 53.38 ± 1.28 | 16.22 ± 2.27 |

On the Concrete Compressive Strength dataset, the results for SelectiveNet are better than those reported in the original paper (Geifman and El-Yaniv, 2019) as it was found that applying a learning rate decay schedule, instead of a constant learning rate as in Geifman and El-Yaniv (2019), significantly boosts performance. Nevertheless, Gumbel-softmax selective networks outperform SelectiveNets at every coverage level on this dataset (Table 3). In the non-calibrated results (Table 4), it is observed that Gumbel-softmax selective networks are also more consistent in obtaining actual (empirical) coverages that match the target coverages without the need for calibration. This translates to more reliable abstention performance in operation.

TABLE 5
Selective mean absolute error and mean squared error on California
Housing dataset. Errors are computed in units of $10,000. Lowest
error rates within each metric are highlighted in bold.

| | Mean absolute error | | Mean squared error | |
|---|---|---|---|---|
| | Gumbel- | | Gumbel- | |
| Coverage | softmax | SelectiveNet | softmax | SelectiveNet |
| 100 | 4.51 ± 0.03 | 4.55 ± 0.05 | 40.20 ± 0.59 | 40.65 ± 0.39 |
| 90 | 4.19 ± 0.05 | 4.36 ± 0.11 | 34.58 ± 0.33 | 36.22 ± 1.38 |
| 80 | 3.92 ± 0.07 | 4.24 ± 0.17 | 30.29 ± 1.20 | 33.87 ± 2.19 |
| 70 | 3.66 ± 0.04 | 3.97 ± 0.18 | 26.92 ± 0.62 | 31.74 ± 1.55 |
| 60 | 3.38 ± 0.09 | 3.99 ± 0.23 | 23.50 ± 1.14 | 29.60 ± 3.29 |
| 50 | 3.22 ± 0.15 | 3.78 ± 0.15 | 20.96 ± 1.35 | 26.69 ± 1.44 |

TABLE 6
Non-calibrated results on the California Housing dataset.

| | Gumbel-softmax | | SelectiveNet | |
|---|---|---|---|---|
| | Empirical | Mean Squared | Empirical | Mean Squared |
| Coverage | Coverage | Error | Coverage | Error |
| 100 | 98.98 ± 0.81 | 38.65 ± 0.81 | 99.52 ± 0.15 | 40.14 ± 0.59 |
| 90 | 89.71 ± 0.59 | 34.44 ± 0.58 | 90.77 ± 0.59 | 36.32 ± 1.37 |
| 80 | 80.64 ± 0.53 | 30.45 ± 1.24 | 81.37 ± 0.27 | 31.62 ± 1.22 |
| 70 | 71.50 ± 0.70 | 27.37 ± 0.75 | 72.15 ± 0.32 | 32.12 ± 1.19 |
| 60 | 61.88 ± 0.71 | 24.04 ± 0.79 | 62.94 ± 0.18 | 30.20 ± 3.05 |
| 50 | 52.52 ± 0.40 | 21.50 ± 1.44 | 53.40 ± 0.34 | 27.26 ± 1.29 |

Calibrated and non-calibrated results for the California Housing dataset are shown in Tables 5 and 6, respectively. Table 5 includes two metrics: mean absolute error and mean squared error. For both metrics, Gumbel-softmax selective networks outperform SelectiveNets at every coverage level. The non-calibrated results (Table 6) show that Gumbel-softmax selective networks provide a better matching between empirical and target coverages for all tested coverages, in line with the observations on the Concrete Compressive Strength dataset. Again, this translates to more reliable abstention performance in operation.

TABLE 7
Selective mean absolute error on Ames Housing
dataset. Errors are computed in units of $10,000.
Lowest error rates are highlighted in bold.

Mean absolute error

| Coverage | Gumbel-softmax | SelectiveNet |
|---|---|---|
| 100 | 1.68 ± 0.07 | 1.64 ± 0.04 |
| 90 | 1.22 ± 0.04 | 1.25 ± 0.05 |
| 80 | 1.10 ± 0.05 | 1.11 ± 0.03 |
| 70 | 1.04 ± 0.01 | 1.07 ± 0.03 |
| 60 | 0.97 ± 0.03 | 1.00 ± 0.04 |
| 50 | 0.95 ± 0.06 | 1.01 ± 0.05 |

Table 7 shows results for the Ames Housing dataset. Again, Gumbel-softmax selective networks outperform SelectiveNets at every coverage level.

With the increasing integration of AI techniques in real-world systems, it has become more and more important to consider how models are integrated with existing infrastructure, and in particular how to train models so that they are aware of their operational context. AI models are often deployed not in isolation, but as part of a larger system, with non-AI logic, legacy processes, or humans in the loop. In operational contexts where the system has the option of falling back on supporting processes when the AI model is uncertain, the option to abstain should ideally be integrated directly in the AI model training—the model should be aware of this system option. The present disclosure enables the abstention option to be directly integrated into training in a rigourous way.

As can be seen from the above description, the selective network training technology described herein represents significantly more than merely using categories to organize, store and transmit information and organizing information through mathematical correlations. The selective network training technology is in fact an improvement to machine learning, as it allows binary selection during training while preserving end-to-end training. This facilitates improvements in training by improving the optimization of the weighted combination of the empirical selective risk and the penalty term that penalizes differences between the empirical coverage and a pre-specified target coverage. Moreover, the selective network training technology is specifically directed to a computer problem, namely challenges in training of selective networks, and specifically improves the performance of a computer system when carrying out training of a selective network. The present technology is therefore confined to machine learning applications, and still more particularly to selective networks.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

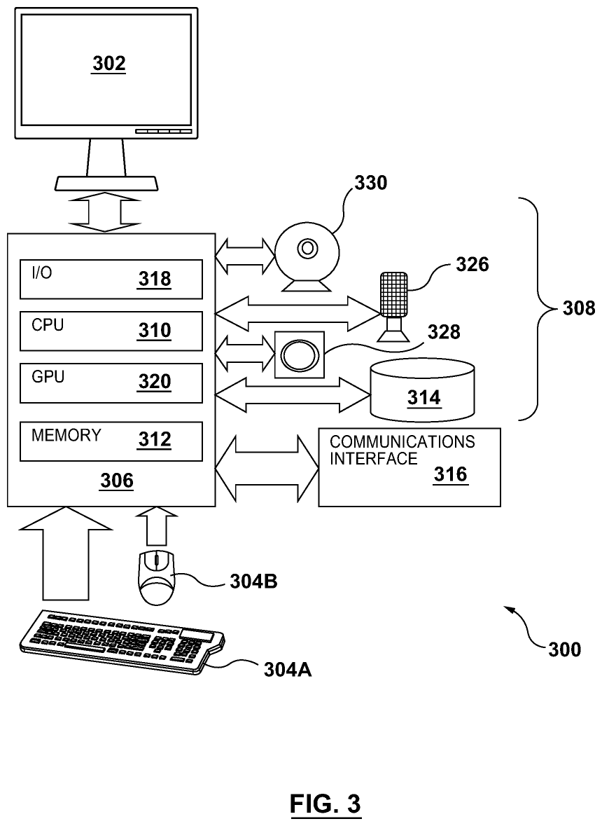

An illustrative computer system in respect of which the technology herein described may be implemented is presented as a block diagram in FIG. 3. The illustrative computer system is denoted generally by reference numeral 300 and includes a display 302, input devices in the form of keyboard 304A and pointing device 304B, computer 306 and external devices 308. While pointing device 304B is depicted as a mouse, it will be appreciated that other types of pointing device, or a touch screen, may also be used.

The computer 306 may contain one or more processors or microprocessors, such as a central processing unit (CPU) 310. The CPU 310 performs arithmetic calculations and control functions to execute software stored in an internal memory 312, preferably random access memory (RAM) and/or read only memory (ROM), and possibly additional memory 314. The additional memory 314 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 314 may be physically internal to the computer 306, or external as shown in FIG. 3, or both.

The computer system 300 may also include other similar means for allowing computer programs or other instructions to be loaded. Such means can include, for example, a communications interface 316 which allows software and data to be transferred between the computer system 300 and external systems and networks. Examples of communications interface 316 can include a modem, a network interface such as an Ethernet card, a wireless communication interface, or a serial or parallel communications port. Software and data transferred via communications interface 316 are in the form of signals which can be electronic, acoustic, electromagnetic, optical or other signals capable of being received by communications interface 316. Multiple interfaces, of course, can be provided on a single computer system 300.

Input and output to and from the computer 306 is administered by the input/output (I/O) interface 318. This I/O interface 318 administers control of the display 302, keyboard 304A, external devices 308 and other such components of the computer system 300. The computer 306 also includes a graphical processing unit (GPU) 320. The latter may also be used for computational purposes as an adjunct to, or instead of, the (CPU) 310, for mathematical calculations.

The external devices 308 include a microphone 326, a speaker 328 and a camera 330. Although shown as external devices, they may alternatively be built in as part of the hardware of the computer system 300.

The various components of the computer system 300 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 312 of the computer 306, or on a computer usable or computer readable medium external to the computer 306, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

### LIST OF REFERENCES

None of the documents cited herein is admitted to be prior art (regardless of whether or not the document is explicitly denied as such). The following list of references is provided without prejudice for convenience only, and without admission that any of the references listed herein is citable as prior art.
[1] Javier Antorán, James Urquhart Allingham, and José Miguel Hernández-Lobato. Depth uncertainty in neural networks. In Advances in Neural Information Processing Systems, 2020.
[2] Charles Corbière, Nicolas Thome, Avner Bar-Hen, Matthieu Cord, and Patrick Pérez. Addressing failure prediction by learning model confidence. In Advances in Neural Information Processing Systems, 2019.
[3] Dheeru Dua and Casey Graff. UCI machine learning repository, 2017. URL http://archive.ics.uci.edu/ml.
[4] Nikita Durasov, Timur Bagautdinov, Pierre Baque, and Pascal Fua. Masksembles for uncertainty estimation. In IEEE/CVF Conference on Computer Vision and Pattern Recognition, 2021.
[5] Michael Dusenberry, Ghassen Jerfel, Yeming Wen, Yian Ma, Jasper Snoek, Katherine Heller, Balaji Lakshminarayanan, and Dustin Tran. Efficient and scalable Bayesian neural nets with rank-1 factors. In International Conference on Machine Learning, 2020.
[6] Jeremy Elson, John (JD) Douceur, Jon Howell, and Jared Saul. Asirra: A captcha that exploits interest-aligned manual image categorization. In ACM Conference on Computer and Communications Security, 2007.
[7] Yarin Gal and Zoubin Ghahramani. Dropout as a Bayesian approximation: Representing model uncertainty in deep learning. In International Conference on Machine Learning, 2016.
[8] Yarin Gal, Jiri Hron, and Alex Kendall. Concrete dropout. In Advances in Neural Information Processing Systems, 2017.
[9] Yonatan Geifman and Ran El-Yaniv. Selective classification for deep neural networks. In Advances in Neural Information Processing Systems, 2017.
[10] Yonatan Geifman and Ran El-Yaniv. SelectiveNet: A deep neural network with an integrated reject option. In International Conference on Machine Learning, 2019.
[11] Emil Julius Gumbel. Statistical theory of extreme values and some practical applications: A series of lectures. Technical report, U.S. Government Printing Office, 1954.
[12] Lang Huang, Chao Zhang, and Hongyang Zhang. Self-adaptive training: beyond empirical risk minimization. In Advances in Neural Information Processing Systems, 2020.
[13] Eric Jang, Shixiang Gu, and Ben Poole. Categorical reparameterization with Gumbel-Softmax. In International Conference on Learning Representations, 2017.
[14] Diederik P. Kingma and Max Welling. Auto-encoding variational Bayes. In International Conference on Learning Representations, 2014.
[15] Alex Krizhevsky. Learning multiple layers of features from tiny images. Technical report, 2009.
[16] Balaji Lakshminarayanan, Alexander Pritzel, and Charles Blundell. Simple and scalable predictive uncertainty estimation using deep ensembles. In Advances in Neural Information Processing Systems, 2017.
[17] Jeremiah Zhe Liu, Zi Lin, Shreyas Padhy, Dustin Tran, Tania Bedrax-Weiss, and Balaji Lakshminarayanan. Simple and principled uncertainty estimation with deterministic deep learning via distance awareness. In Advances in Neural Information Processing Systems, 2020.
[18] Shuying Liu and Weihong Deng. Very deep convolutional neural network based image classification using small training sample size. In 2015 3 rd IAPR Asian conference on pattern recognition (ACPR), pages 730-734. IEEE, 2015.
[19] Ziyin Liu, Zhikang Wang, Paul Pu Liang, Russ R Salakhutdinov, Louis-Philippe Morency, and Masahito Ueda. Deep gamblers: Learning to abstain with portfolio theory. In Advances in Neural Information Processing Systems, 2019.
[20] Chris J. Maddison, Andriy Mnih, and Yee Whye Teh. The Concrete distribution: A continuous relaxation of discrete random variables. In International Conference on Learning Representations, 2017.
[21] Wesley J Maddox, Pavel Izmailov, Timur Garipov, Dmitry P Vetrov, and Andrew Gordon Wilson. A simple baseline for bayesian uncertainty in deep learning. Advances in Neural Information Processing Systems, 2019.
[22] Andrey Malinin, Anton Ragni, Kate Knill, and Mark Gales. Incorporating uncertainty into deep learning for spoken language assessment. In Annual Meeting of the Association for Computational Linguistics, 2017.
[23] R. Kelley Pace and Ronald Barry. Sparse spatial autoregressions. Statistics and Probability Letters, 33(3):291-297, 1997.
[24] Danilo Jimenez Rezende, Shakir Mohamed, and Daan Wierstra. Stochastic backpropagation and approximate inference in deep generative models. In International Conference on Machine Learning, 2014.
[25] I-Cheng Yeh. Modeling of strength of high performance concrete using artificial neural networks. Cement and Concrete Research, 28(12):1797-1808, 1998.
[26] Dean De Cock. Ames housing dataset, 2011. URL https://www.kaggle.com/c/house-prices-advanced-regression.
[27] Yonglong Tian, Dilip Krishnan, and Phillip Isola. Contrastive multiview coding. arXiv preprint arXiv: 1906.05849, 2019.
[28] Kaiming He, Xiangyu Zhang, Shaoqing Ren, and Jian Sun. Deep residual learning for image recognition. In IEEE Conference on Computer Vision and Pattern Recognition (CVPR), 2016.
[29] Leo Feng, Mohamed Osama Ahmed, Hossein Hajimirsadeghi, and Amir Abdi. Stop overcomplicating selective classification: Use max-logit. arXiv preprint arXiv:2206.09034, 2022.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A method of training a selective network, wherein:
the selective network includes a selection node for selecting whether to make a prediction;
wherein:
during training, the selection node is reparameterized as a differentiable function of learnable parameters acting on noise from a base distribution;
wherein the differentiable function approximates a sampling from a categorical distribution.

2. The method of claim 1, wherein the base distribution is the Gumbel distribution.

3. The method of claim 2, further comprising:
during at least one forward pass of the network, using argmax to perform selection at the selection node; and
during at least one backward pass of the network, using a softmax approximation of the argmax at the selection node to compute gradients.

4. The method of claim 3, wherein the softmax approximation uses temperature annealing.

5. The method of claim 1, wherein the noise is i.i.d. noise.

6. The method of claim 1, wherein the prediction is a classification.

7. The method of claim 1, wherein the prediction is a numerical value.

8. The method of claim 1, wherein the selective network is one of a convolutional network, a fully connected network, a residual network, and a recurrent network.

9. A data processing system, comprising;
at least one processor;
a memory coupled to the at least one processor, the memory containing instructions which, when executed by the at least one processor, cause the at least one processor to:
train a selective network, wherein the selective network includes a selection node for selecting whether to make a prediction; and
during training, reparameterize the selection node as a differentiable function of learnable parameters acting on noise from a base distribution, wherein the differentiable function approximates a sampling from a categorical distribution.

10. The data processing system of claim 9, wherein the base distribution is the Gumbel distribution.

11. The data processing system of claim 10, wherein the instructions, when executed by the at least one processor, further cause the at least one processor to:
during at least one forward pass of the network, use argmax to perform selection at the selection node; and
during at least one backward pass of the network, use a softmax approximation of the argmax at the selection node to compute gradients.

12. The data processing system of claim 11, wherein the softmax approximation uses temperature annealing.

13. The data processing system of claim 9, wherein the noise is i.i.d. noise.

14. The data processing system of claim 9, wherein the prediction is a classification.

15. The data processing system of claim 9, wherein the prediction is a numerical value.

16. The data processing system of claim 9, wherein the selective network is one of a convolutional network, a fully connected network, a residual network, and a recurrent network.

17. A computer program product comprising a non-transitory tangible computer-readable medium having computer-readable instructions embodied therewith, wherein the instructions, when executed by at least one processor, cause the at least one processor to:
train a selective network, wherein the selective network includes a selection node for selecting whether to make a prediction; and
during training, reparameterize the selection node as a differentiable function of learnable parameters acting on noise from a base distribution, wherein the differentiable function approximates a sampling from a categorical distribution.

18. The computer program product of claim 17, wherein the base distribution is the Gumbel distribution.

19. The computer program product of claim 18, wherein the instructions, when executed by the at least one processor, cause the at least one processor to:
during at least one forward pass of the network, use argmax to perform selection at the selection node; and
during at least one backward pass of the network, use a softmax approximation of the argmax at the selection node to compute gradients.

20. The computer program product of claim 19, wherein the softmax approximation uses temperature annealing.

21. The computer program product of claim 17, wherein the noise is i.i.d. noise.

22. The computer program product of claim 17, wherein the prediction is a classification.

23. The computer program product of claim 17, wherein the prediction is a numerical value.

24. The computer program product of claim 17, wherein the selective network is one of a convolutional network, a fully connected network, a residual network, and a recurrent network.
